(19) United States
(12) Patent Application Publication
(10) Pub. No.: US 2007/0221100 A1
(43) Pub. Date: Sep. 27, 2007

(54) Process for the preparation of self-glazed geopolymer tile from fly ash and blast furnace slag

(76) Inventors: Sanjay Kumar, Jamshedpur (IN); Rakesh Kumar, Jamshedpur (IN); Mittra Balai Kumar, Jamshedpur (IN); Surya Pratap Mehrotra, Jamshedpur (IN)

Correspondence Address: KREMBLAS, FOSTER, PHILLIPS & POLLICK, 7632 SLATE RIDGE BOULEVARD, REYNOLDSBURG, OH, 43068, US

(21) Appl. No.: 11/707,354

(22) Filed: Feb. 16, 2007

(30) Foreign Application Priority Data
Mar. 22, 2006 (IN) 780/DEL/2006

(51) Int. Cl. C04B 18/06

(52) U.S. Cl. 106/707; 106/705

(57) ABSTRACT

The present invention provides a process for the preparation of self glazed geopolymer tile using fly ash and granulated blast furnace slag. In the process of the present invention, the granulated blast furnace slag is fine grounded and/or mechanically activated in conventional grinding mills or high-energy mills. The fly ash, which is found in powder form and fine powder of granulated blast furnace slag, is thoroughly mixed to make a homogenous mixture. The alkaline solution is added into the mixture to initiate the geopolymerization. The ratio of water to powder is optimised to obtain a consistent paste to be used for vibration casting. During the casting, the consistent paste flows inside the mould and the particles settles at mirror finished surface of mould, giving rise to dense and smooth surface.

### FIELD OF THE INVENTION

The present invention relates to a process for the production of self-glazed geopolymer tile from fly ash and granulated blast furnace slag. The invention particularly relates to a process for the production of self-glazed geopolymer tile from fly ash and granulated blast furnace slag, which is waste materials of thermal power plant and iron & steel plant respectively.

### PRIOR ART AND BACKGROUND OF THE INVENTION

There is no known process to produce self-glazed tiles. The products produced by the process of present invention will be self-glazed which is a novel invention. The product will use fly ash and granulated blast furnace slag as the main component, which is industrial wastes and abundantly available in India and worldwide. The process does not require costly raw material, large energy consumption and also no CO₂ emission. Also the processing steps are simple and easy. The products produced by the process of present invention may obtain glazed surface and good compressive strength in short time, have good volume stability, excellent durability and high fire resistance. The self-glazed geopolymer tile of the present invention can be produced in different shapes and sizes, and different colours and designs. These self-glazed tiles shall be useful as decorative wall tiles for building and construction industry.

The hitherto known processes to produce ceramic tiles use pure material such as kaolinite, feldspar, quartz, wollastonite, talc, etc as main raw material (Dana, K, Das, S and Das, S. K, 2004, J. Eur. Ceram. Soc. 24: 3169-3175). The existing process to produce ceramic tiles consisted of crushing and fine grinding of raw material, proportioning and wet milling of raw materials in a milling device such as ball mill, screening of milled slurry to remove the course particles, spray drying for obtaining dry spherical particles, compaction in a hydraulic press in the desired shape, drying in the oven to remove the moisture, glazing and then firing at a temperature in the range of 850°-1250° C. The glazing of the tile includes the preparation of glaze slurry which contains costly raw materials such as frit, zircon, opacifier, feldspar etc. Glazing is done in glaze booth using spray guns. During the firing, the glaze composition melts and during cooling it solidifies at the surface of tile body and forms a impervious glassy glazed layer.

Another known process to produce tiles includes crushing and fine grinding of raw material, proportioning and wet milling of raw materials in a milling device such as ball mill, screening of milled slurry to remove the course particles, spray drying for obtaining dry spherical particles, compaction in a hydraulic press in the desired shape, drying in the oven to remove the moisture, firing at a temperature in the range of 1150°-1350° C. The glazing effect on the surface of the tile is obtained by polishing the tile surface coarse, medium and fine silicon carbide powder followed by polishing with alumina and diamond paste (Kumar, S, Singh K. K and Rao, P. R, 2001, J. Mater. Sci. 36: 5917-5922).

Yet another known process to produce floor and wall tile includes geopolymerization of alumino-silicate minerals (Method for manufacturing floor and wall stone tiles with geopolymers French Patent FR 2.528.818, 22/08/1982, Joseph Davidovits, Claude Boutterin).

The process consisted of proportioning and blending of alumino-silicate minelars such as kaolinite, quartz, etc in a highly alkaline medium followed by heat treatment in the range of 300°-700° C.

The hitherto known process have the following limitations:
a. The production cost of tiles is relatively high when it uses costly raw materials such as pure silica, alumino-silicate minerals, talc, wollastonite, etc. as main ingredient.
b. The formation of ceramic tiles is an energy intensive process as the green tiles are fired at a temperature in the range 950°-1250° C. for 2 to 8 hours.
c. The tiles produced are in unglazed form. Glazing of the tiles is material intensive, cost intensive and energy intensive process.

Traditionally, geopolymer based building materials are produced by intermixing of alumino-silicate bearing minerals such as kaolin with sodium and potassium based alkaline activator, curing at room temperature followed by curing at elevated temperature (J. Davodovits, Journal of Thermal Analysis, Vol 37, pp 1633-1656, 1991). Reference may be made to U.S. Pat. No. 4,472,199 on Synthetic mineral polymer compound of the silico-aluminate family and preparation process by Davidovits et al, wherein cast or moulded geopolymers can be produced for zeolite application. Another reference may be made to U.S. Pat. No. 4,509,985 on Early high strength mineral polymer by Davidovits et al, , wherein geopolymer can be produced by adding a reactant mixture consisting of alumino-silicate oxide with the aluminium cation in sodium or potassium based activators. Yet another reference may be made to J. C. Swanepoel and C. A. Strydom “Utilisation of fly ash in a geopolymeric material, Applied Geochemistry, Volume 17, Issue 8, pp 1143-1148, 2002” wherein fly ash was used as one of the ingredient of geopolymer. Reference may also be made to A. Palomo et al, “Alkali-activated fly ashes, a cement for the future, Cem. Concr. Res.Vol 29, pp 1323-1329, 1999”, wherein the potential for fly ash as raw material for geopolymer has been explored. According to literature and patent survey and available information, it may be mentioned that at present no process is available to produce self-glazed geopolymer tile using fly ash and granulated blast furnace slag. The purpose of this development is to use abundantly available waste materials such as fly ash and granulated blast furnace slag, which is causing environmental pollution, to produce novel product such as self-glazed geopolymer tile for building application.

### OBJECT OF THE INVENTION

The main object of the present investigation is to provide a process for the production of self-glazed geopolymer tile using fly ash and granulated blast furnace slag, which obviates the drawbacks as detailed above.

Another object of the present invention is to provide a process to produce self-glazed geopolymer tile whereby the energy consumption is significantly reduced.

Yet another object of the present invention is to provide a process to produce self-glazed geopolymer tile whereby the cost of production is appreciably lowered and the properties of the product is improved.

Still yet another object of the present invention is to provide a new process produce self-glazed geopolymer tile whereby the aesthetic appearance of the product is improved.

### SUMMARY OF THE INVENTION

Accordingly, the present invention provides a process for the production of self glazed geopolymer tile using fly ash and granulated blast furnace slag, the said process comprising the steps of:
i fine grinding and/or mechanically activating the granulated blast furnace slag in a milling device for a period of 30 to 120 minutes in either dry or wet condition and reducing the size of the above said activated slag below 100 microns,
ii preparing about N/10 solution of alkaline activator by mixing water and alkaline activator ash in a ratio of 10:1 (v/v) followed by edging for a period of 8 to 12 hours,
iii mixing intimately of 10 to 40% by weight of ground granulated blast furnace slag obtain in step (i) with 60 to 90% by weight fly ash obtained from coal fired power plants for a period of 5 to 30 minutes under stirring,
iv mixing intimately alkaline activator solution obtain in step (ii) with a resultant mixture obtain in step (iii) in the ratio of 1:2 to 1:4 (v/w) for a period of 5 to 15 minutes under stirring,
v adding the superplasticizer in the slurry obtained in step (iv) in the range of 0.1-2% by weight of slurry,
vi preparing a non-sticky mirror surface bottom of the tile mould by known method,
vii vibro-casting the slurry obtained in step (iv) in a tile mould,
viii keeping the above said mould with cast tile of step (vii) in a humidity ranging between 90 to 98% for a period ranging between 1 to 8 hours,
ix releasing the cast tiles from the mould and drying it at an ambient temperature for a period of 2 to 24 hours,
x heating the dried articles obtained in step (ix) in an oven at a temperature in the range of 50 to 350° C. for a period of 2 to 8 hours followed by cooling to a temperature of 20-20° C. to obtain the desired product.

In an embodiment of the present invention, the fly ash and granulated blast furnace slag used is selected from the following composition range:

| | Granulated blast | Constituent |
|---|---|---|
| Fly ash | furnac slag | (wt. %) |
| 40–70 | 25–35 | SiO₂ |
| 20–30 | 15–25 | Al₂O₃ |
| 0–5 | 0–1 | Fe₂O₃ |
| 0–5 | 25–40 | CaO |
| 0–1 | 4–15 | MgO |
| 0–2 | 0–1 | MnO |

In another embodiment of the present invention, the alkaline activator ash used is selected from the group consisting of sodium oxide, sodium hydroxide, sodium silicate, sodium nitrate, potassium oxide, potassium hydroxide, and potassium silicate.

In yet another embodiment of the present invention, the superplastisizer used is selected from the group consisting of calcium lignosulphonates, sodium lignosulphonates, sodium hexametaphosphate, sodium tripoly phosphate, butyl acrylate, and methoxy cellulose.

In still another embodiment of the present invention, the milling device used is selected from the group consisting of ball mill, roller press, vibration mill, attrition mill, jet mill, and planetary mill.

In still another embodiment of the present invention, the self glazed geopolymer tiles used have the following range of properties:

| | | |
|---|---|---|
| (a) | Compressive strength | 20–50 MPa |
| (b) | Fire resistance | withstand 1000° C. |
| (c) | Acid resistance | Excellent |
| (d) | Straightness of the side | >95% |
| (e) | Rectangularity | >95% |
| (f) | Surface finish | glazed and free from defect |
| (g) | Bulk density | 1.5–2.5 gm/cc |
| (h) | Water absorption | 10–25% |
| (i) | Hardness | >4 on Mohs Scale |

### DETAILED DESCRIPTION OF THE INVENTION

The fly ash used in the present invention contains SiO₂, Al₂O₃ and Fe₂O₃ and is partly crystalline and partly amorphous in nature. The granulated blast furnace slag contains CaO, SiO₂ and Al₂O₃ and is mostly amorphous in nature.

In the process of the present invention, the granulated blast furnace slag is fine grounded and/or mechanically activated in conventional grinding mills or high-energy mills. The fly ash, which is found in powder form and fine powder of granulated blast furnace slag, is thoroughly mixed to make a homogenous mixture. The alkaline solution is added into the mixture to initiate the geopolymerization. The ratio of water to powder is optimised to obtain a consistent paste to be used for vibration casting. During the casting, the consistent paste flows inside the mould and the particles settles at mirror finished surface of mould, giving rise to dense and smooth surface. The cast tile is cured at room temperature during which geopolymerization reactions start. Two type of reaction occurs in the material, (a) The paste is cured at room temperature during which the dissolution of silica and alumina. After the initial dissolution, the paste is heat treated at the temperature in the range of 60-300° C. In the enhanced curing condition dissolution of silico aluminate proceeds simultaneously with the gel formation and poly-condensation reactions and results into formation of polymeric Si—O—Al—O bonds called polysialate. Formation of polysialate results into setting and strength development of tiles, and (b) the latent hydraulic property of granulated blast furnace slag is enhanced at elevated temperature curing. During the hydration reactions, the CaO and SiO₂ present in slag reacts with water and form the C—S—H gel (C═CaO, S═SiO₂, H═H₂O), which is cementitious in nature. Formation of C—S—H gel accelerates the setting time at the earlier stage and also contribute towards strength development at later stage. During the above two reactions, geopolymerisation is more intensive at the bottom surface due to accumulation of more alkalies and load of overburden. A different reaction mechanism occurs at the bottom surface leading to formation of more and closely packed alumino-silicate gel. As a result, glaze surface occurs at the bottom.

Novelty of the present invention is that the glazed surface occurs on the geopolymer tile automatically and without any secondary processing. Another novelty is that the tile uses two major industrial waste, fly ash and granulated blast furnace slag, as the major raw material (up to 95% of total composition).

The following examples are given by way of illustration and should not be construed to limit the scope of invention.

### EXAMPLE-1

Granulated blast furnace slag was ball milled for 120 minutes to get the particle size <100 μm. N/10 solution of alkaline activator was prepared by mixing the water and potassium hydroxide in the ratio of 10:1 and then edging for 8 hours at ambient temperature. 900 grams of fly ash and 100 grams of ball milled slag was thoroughly mixed for 15 minutes in a mechanical mixer. 1 kg of fly ash slag mixture and 500 ml of alkaline activator was throughly mixed for 5 minutes using stirrer. 5 gm of calcium lignosulphonate was added into the mixture. The slurry obtained was vibro-casted into tile mould with non-sticy mirror finished surface and then kept in 95% relative humidity for 4 hours. Then the tiles were released from mould and then dried at ambient temperature for 12 hours followed by drying at 250° C. in an electrical oven for 6 hours and then cooled to ambient temperature for various tests. The properties obtained are furnished in table 1.

TABLE 1
Properties of self-glazed geopolymer tile discussed above

| Properties | Values |
|---|---|
| Compressive strength | 30 MPa |
| Fire resistance | withstand 1000° C. |
| Acid resistance | Excellent |
| Straightness of the side | >95% |
| Rectangularity | >95% |
| Surface finish | glazed and free from defect |
| Bulk density | 1.9 gm/cc |
| Water absorption | 16% |
| Hardness | >4 on Mohs Scale |

### EXAMPLE-2

Granulated blast furnace slag was vibratory milled for 60 minutes to get the particle size <100 μm. N/10 solution of alkaline activator was prepared by mixing the water and sodium hydroxide in the ratio of 10:1 and then edging for 8 hours at ambient temperature. 700 grams of fly ash and 300 grams of vibratory milled slag was thoroughly mixed for 15 minutes in a mechanical mixer. 1 kg of fly ash slag mixture and 300 ml of alkaline activator was throughly mixed for 5 minutes using stirrer. 10 gm of sodium hexametaphosphate was added into the mixture. The slurry obtained was vibro-casted into tile mould with non-sticy mirror finished surface and then kept in 95% relative humidity for 6 hours. Then the tiles were released from mould and then dried at ambient temperature for 12 hours followed by drying at 150° C. in an electrical oven for 8 hours and then cooled to ambient temperature for various tests. The properties obtained are furnished in table 2.

TABLE 2
Properties of self-glazed geopolymer tile discussed above

| Properties | Values |
|---|---|
| Compressive strength | 38 MPa |
| Fire resistance | withstand 1000° C. |
| Acid resistance | Excellent |
| Straightness of the side | >95% |
| Rectangularity | >95% |
| Surface finish | glazed and free from defect |
| Bulk density | 2.3 gm/cc |
| Water absorption | 15% |
| Hardness | >4 on Mohs Scale |

### EXAMPLE-3

Granulated blast furnace slag was attrition milled for 30 minutes to get the particle size <100 μm. N/10 solution of alkaline activator was prepared by mixing the water and sodium silicate in the ratio of 10:1 and then edging for 12 hours at ambient temperature. 600 grams of fly ash and 400 grams of attrition milled slag was thoroughly mixed for 15 minutes in a mechanical mixer. 1 kg of fly ash slag mixture and 350 ml of alkaline activator was throughly mixed for 10 minutes using stirrer. 10 gm of sodium lignosulphonate was added into the mixture. The slurry obtained was vibro-casted into tile mould with non-sticy mirror finished surface and then kept in 95% relative humidity for 8 hours. Then the tiles were released from mould and then dried at ambient temperature for 12 hours followed by drying at 70° C. in an electrical oven for 12 hours and then cooled to ambient temperature for various tests. The properties obtained are furnished in table 3.

TABLE 3
Properties of self-glazed geopolymer tile discussed above

| Properties | Values |
|---|---|
| Compressive strength | 45 MPa |
| Fire resistance | withstand 1000° C. |
| Acid resistance | Excellent |
| Straightness of the side | >95% |
| Rectangularity | >95% |
| Surface finish | glazed and free from defect |
| Bulk density | 2.2 gm/cc |
| Water absorption | 12% |
| Hardness | >4 on Mohs Scale |

### EXAMPLE-4

Granulated blast furnace slag was ball milled for 120 minutes to get the particle size <100 μm. N/10 solution of alkaline activator was prepared by mixing the water and sodium hydroxide in the ratio of 10:1 and then edging for 12 hours at ambient temperature. 500 grams of fly ash and 500 grams of ball milled slag was thoroughly mixed for 15 minutes in a mechanical mixer. 1 kg of fly ash slag mixture and 400 ml of alkaline activator was throughly mixed for 15 minutes using stirrer. 15 gm of sodium tripolyphosphate was added into the mixture. The slurry obtained was vibro-casted into tile mould with non-sticy mirror finished surface and then kept in 90% relative humidity for 5 hours. Then the tiles were released from mould and then dried at ambient temperature for 12 hours followed by drying at 300° C. in an electrical oven for 5 hours and then cooled to ambient temperature for various tests. The properties obtained are furnished in table 4.

TABLE 4
Properties of self-glazed geopolymer tile discussed above

| Properties | Values |
|---|---|
| Compressive strength | 50 MPa |
| Fire resistance | withstand 1000° C. |
| Acid resistance | Excellent |
| Straightness of the side | >95% |
| Rectangularity | >95% |
| Surface finish | glazed and free from defect |
| Bulk density | 2.5 gm/cc |
| Water absorption | 11% |
| Hardness | >4 on Mohs Scale |

### Advantages of the Invention

The main advantages of the present invention are:
1. Self glazed geopolymer tile can be produced by the process of present invention, where glazing occurs automatically on tile surface, thereby no additional processing or cost for glazing is required.
2. The process utilises very high proportion of abundantly available industrial waste (fly ash and granulated blast furnace slag) as major raw material to produce self glazed geopolymer tile, thereby the cost of production is considerably reduced in comparison to the known process.
3. The process of the present invention is helpful in resource conservation by replacing costly raw materials e.g. silica, kaolin, talc, wollostonite, etc. by the industrial wastes.
4. The process involves low temperature processing (50-300° C.), thereby helpful in energy conservation.
5. The process uses simple and easy steps and no CO₂ is emitted during processing.

1. A process for the preparation of self glazed geopolymer tile using fly ash and granulated blast furnace slag, the said process comprising the steps of:
(i) fine grinding and/or mechanically activating the granulated blast furnace slag in a milling device for a period of 30 to 120 minutes in either dry or wet condition and reducing the size of the above said activated slag below 100 microns,
(ii) preparing about N/10 solution of alkaline activator by mixing water and alkaline activator ash in a ratio of about 10:1 (v/v) followed by edging for a period of 8 to 12 hours,
(iii) mixing intimately of 10 to 40% by weight of ground granulated blast furnace slag obtain in step (i) with 60 to 90% by weight fly ash obtained from coal fired power plants for a period of 5 to 30 minutes under stirring,
(iv) mixing intimately alkaline activator solution obtain in step (ii) with a resultant mixture obtain in step (iii) in the ratio of 1:2 to 1:4 (v/w) for a period of 5 to 15 minutes under stirring,
(v) adding the superplasticizer in the slurry obtained in step (iv) in the range of 0.1-2% by weight of slurry,
(vi) preparing a non-sticky mirror surface bottom of the tile mould by known method,
(vii) vibro-casting the slurry obtained in step (iv) in a tile mould,
(viii) keeping the above said mould with cast tile of step (vii) in a humidity ranging between 90 to 98% for a period ranging between 1 to 8 hours,
(ix) releasing the cast tiles from the mould and drying it at an ambient temperature for a period of 2 to 24 hours,
(x) heating the dried articles obtained in step (ix) in an oven, at a temperature in the range of 50 to 350° C. for a period of 2 to 8 hours followed by cooling to a temperature of 20-20° C. to obtain the desired product.

2. A process according to claim 1, wherein, the fly ash and granulated blast furnace slag used is selected from the following composition range:

| | Granulated blast | Constituent |
|---|---|---|
| Fly ash | furnac slag | (wt. %) |
| 40–70 | 25–35 | SiO₂ |
| 20–30 | 15–25 | Al₂O₃ |
| 0–5 | 0–1 | Fe₂O₃ |
| 0–5 | 25–40 | CaO |
| 0–1 | 4–15 | MgO |
| 0–2 | 0–1 | MnO |

3. A process according to claim 1, wherein, the alkaline activator ash used is selected from the group consisting of sodium oxide, sodium hydroxide, sodium silicate, sodium nitrate, potassium oxide, potassium hydroxide, and potassium silicate.

4. A process according to claim 1, wherein, the superplastisizer used is selected from the group consisting of calcium lignosulphonates, sodium lignosulphonates, sodium hexametaphosphate, sodium tripoly phosphate, butyl acrylate, and methoxy cellulose.

5. A process according to claim 1, wherein, the milling device used is selected from the group consisting of ball mill, roller press, vibration mill, attrition mill, jet mill, and planetary mill.

6. A process according to claim 1, wherein, the self glazed geopolymer tile obtained has the following properties:

| | | |
|---|---|---|
| (a) | Compressive strength | 20–50 MPa |
| (b) | Fire resistance | withstand 1000° C. |
| (c) | Acid resistance | Excellent |
| (d) | Straightness of the side | >95% |
| (e) | Rectangularity | >95% |
| (f) | Surface finish | glazed and free from defect |
| (g) | Bulk density | 1.5–2.5 gm/cc |
| (h) | Water absorption | 10–25% |
| (i) | Hardness | >4 on Mohs Scale |
